(19) United States
(12) Patent Application Publication
(10) Pub. No.: US 2026/0360321 A1
(43) Pub. Date: Nov. 12, 2026

(54) DISPLAY DEVICE AND ELECTRONIC DEVICE INCLUDING THE SAME

(71) Applicant: Samsung Display Co., Ltd., Yongin-si (KR)

(72) Inventors: HYUN-CHOL BANG, Yongin-si (KR); Kiwook Kim, Yongin-si (KR); Sojung Yoon, Yongin-si (KR)

(73) Assignee: Samsung Display Co., Ltd., Yongin-si (KR)

(21) Appl. No.: 19/638,883

(22) Filed: Apr. 3, 2026

(30) Foreign Application Priority Data
May 8, 2025 (KR) 10-2025-0059544

(51) Int. Cl. G09G 3/3275; G09G 3/32; G09G 3/3266

(52) U.S. Cl. CPC G09G 3/3275; G09G 3/32; G09G 3/3266; G09G 2300/0426; G09G 2310/0267; G09G 2310/0275; G09G 2310/0297

(57) ABSTRACT

A display device includes a substrate including a main area and a sub-area extending from a side of the main area, the main area including a display area in which a plurality of emission areas are disposed in a first direction and a second direction, and a non-display area around the display area, a circuit array layer on the substrate and including a plurality of pixel drivers respectively corresponding to the plurality of emission areas, data lines configured to transmit a data signal to the plurality of pixel drivers, and demultiplexer (demux) circuits in a demux area that is in the non-display area, and a display driving circuit in the sub-area of the substrate and configured to supply corresponding data driving signals to the data lines, where one of the demux circuits is configured to output two or more data signals based on one of the data driving signals.

### CROSS-REFERENCE TO RELATED APPLICATION

This application is based on and claims priority to Korean Patent Application No. 10-2025-0059544, filed on May 8, 2025, in the Korean Intellectual Property Office, the disclosure of which is incorporated by reference herein in its entirety.

### BACKGROUND

### Field

The present disclosure relates to a display device and an electronic device including the same.

### DESCRIPTION OF RELATED ART

As the information society has developed, the demand for display devices for displaying images has increased in various forms. For example, display devices are applied to various electronic devices, such as smartphones, digital cameras, notebook computers, navigation devices, and smart televisions.

A display device may include a display panel which emits light for displaying an image and a driver which supplies signals or power for driving the display panel.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

One or more embodiments provide a display device in which a demultiplexer (demux) area is disposed on an opposite side of a display driving circuit so that an amount of a non-display area around the display driving circuit is reduced.

Additional aspects will be set forth in part in the description which follows and, in part, will be apparent from the description, or may be learned by practice of the presented embodiments.

According to an aspect of an example embodiment, a display device may include a substrate including a main area and a sub-area extending from a side of the main area, the main area including a display area in which a plurality of emission areas are disposed in a first direction and a second direction, and a non-display area around the display area, a circuit array layer on the substrate and including a plurality of pixel drivers respectively corresponding to the plurality of emission areas, data lines configured to transmit a data signal to the plurality of pixel drivers, and demultiplexer (demux) circuits in a demux area that is in the non-display area, and a display driving circuit in the sub-area of the substrate and configured to supply corresponding data driving signals to the data lines, where one of the demux circuits is configured to output two or more data signals based on one of the data driving signals, the circuit array layer includes spider lines including first spider lines and extending from the display driving circuit, and demux connection lines respectively connected to the first spider lines, and one of the demux connection lines corresponds to a plurality of data lines among the data lines.

The demux area may be on a first side of the non-display area, and the display driving circuit may be on a second side of the non-display area that is opposite to the first side in the second direction.

The spider lines may include second spider lines connected to a floating line.

The floating line may be in a floating state.

The floating line may include a line configured to apply a voltage to the plurality of pixel drivers.

Each of the demux connection lines may extend from the display area toward the demux area.

The circuit array layer may include demux input lines respectively connecting the demux connection lines to the demux circuits, and demux output lines respectively connecting the demux circuits to the data lines, and one of the demux input lines may correspond to a plurality of demux output lines among the demux output lines.

The circuit array layer may include scan lines extending in the first direction and configured to transmit a scan signal to the plurality of pixel drivers.

The scan lines may cross the data lines.

The non-display area may include a scan driving circuit area adjacent to at least one side of the display area in the first direction, the circuit array layer may include a scan driving circuit corresponding to the scan driving circuit area, and the scan driving circuit may be configured to respectively supply scan signals to the scan lines.

According to an aspect of an example embodiment, a display device may include a substrate including a main area and a sub-area extending from a side of the main area, the main area including a display area in which a plurality of emission areas are disposed in a first direction and a second direction, and a non-display area around the display area, a circuit array layer on the substrate and including a plurality of pixel drivers respectively corresponding to the plurality of emission areas, data lines configured to transmit a data signal to the plurality of pixel drivers, and demux circuits in a demux area that is in the non-display area, the demux area being on a first side of the non-display area, and a display driving circuit in the sub-area of the substrate and configured to supply corresponding data driving signals to the data lines, where one of the demux circuits is configured to output two or more data signals based on one of the data driving signals, the circuit array layer includes spider lines including first spider lines and extending from the display driving circuit, and demux connection lines respectively connected to the first spider lines, one of the demux connection lines corresponds to a plurality of data lines among the data lines, and the display driving circuit is on a second side of the non-display area that is opposite to the first side in the second direction.

The spider lines may include second spider lines connected to a floating line.

The floating line may be in a floating state.

The floating line may include a line configured to apply a voltage to the plurality of pixel drivers.

Each of the demux connection lines may extend from the display area toward the demux area.

The circuit array layer may include demux input lines respectively connecting the demux connection lines to the demux circuits, and demux output lines respectively connecting the demux circuits to the data lines, and one of the demux input lines may correspond to a plurality of demux output lines among the demux output lines.

The circuit array layer may include scan lines extending in the first direction and configured to transmit a scan signal to the plurality of pixel drivers.

The scan lines may cross the data lines.

The non-display area may include a scan driving circuit area adjacent to at least one side of the display area in the first direction, the circuit array layer may include a scan driving circuit corresponding to the scan driving circuit area, and the scan driving circuit may be configured to respectively supply scan signals to the scan lines.

According to an aspect of an example embodiment, an electronic device may include a display device, the display device may include a substrate including a main area and a sub-area extending from a side of the main area, the main area including a display area in which a plurality of emission areas are disposed in a first direction and a second direction, and a non-display area around the display area, a circuit array layer on the substrate and including a plurality of pixel drivers respectively corresponding to the plurality of emission areas, data lines configured to transmit a data signal to the plurality of pixel drivers, and demux circuits in a demux area that is in the non-display area, and a display driving circuit in the sub-area of the substrate and configured to supply corresponding data driving signals to the data lines, where one of the demux circuits is configured to output two or more data signals based on one of the data driving signals, the circuit array layer includes spider lines including first spider lines and extending from the display driving circuit, and demux connection lines respectively connected to the first spider lines, one of the demux connection lines corresponds to a plurality of data lines among the data lines.

According to an aspect of an example embodiment, a display device may include a substrate including a main area and a sub-area extending from a side of the main area, the main area including a display area in which a plurality of emission areas are disposed in a first direction and a second direction, and a non-display area around the display area, the non-display area including a first side adjacent to the sub-area and a second side opposite to the first side in the first direction with the display area therebetween, a circuit array layer on the substrate and including a plurality of pixel drivers respectively corresponding to the plurality of emission areas, data lines configured to transmit a data signal to the plurality of pixel drivers, and demux circuits in a demux area that is in the second side of the non-display area, and a display driving circuit in the sub-area of the substrate and configured to supply corresponding data driving signals to the data lines, where one of the demux circuits is configured to output two or more data signals based on one of the data driving signals, the circuit array layer includes spider lines including first spider lines and extending from the display driving circuit to the demux area, and demux connection lines respectively connected to the first spider lines, and one of the demux connection lines corresponds to a plurality of data lines among the data lines.

### BRIEF DESCRIPTION OF DRAWINGS

The above and other aspects, features, and advantages of certain example embodiments of the present disclosure will be more apparent from the following description taken in conjunction with the accompanying drawings, in which:

FIG. 1 is a perspective view illustrating a display device according to an embodiment;

FIG. 2 is a plan view illustrating the display device of FIG. 1;

FIG. 3 is a cross-sectional view illustrating an example of a surface taken along line I-I' of FIG. 2;

FIG. 4 is a plan view illustrating a main area and a sub-area in the display device of FIG. 1;

FIG. 5 is a cross-sectional view illustrating an example of a portion taken along line II-II' of FIG. 2;

FIG. 6 is a diagram illustrating region A of FIG. 4, according to an embodiment;

FIG. 7 is an enlarged view illustrating region B of FIG. 6, according to an embodiment;

FIG. 8 is an enlarged view illustrating a portion of a display area according to an embodiment;

FIG. 9 is an equivalent circuit diagram of an example of a pixel driver of FIG. 7;

FIG. 10 is an equivalent circuit diagram of another example of the pixel driver of FIG. 7;

FIG. 11 is an equivalent circuit diagram of a demultiplexer (demux) circuit according to an embodiment;

FIG. 12 is an equivalent circuit diagram of a demux circuit according to an embodiment;

FIG. 13 is a block diagram of an electronic device according to an embodiment; and

FIG. 14 is a diagram of electronic devices according to various embodiments.

### DETAILED DESCRIPTION

Hereinafter, example embodiments of the disclosure will be described in detail with reference to the accompanying drawings. The same reference numerals are used for the same components in the drawings, and redundant descriptions thereof will be omitted. The embodiments described herein are example embodiments, and thus, the disclosure is not limited thereto and may be realized in various other forms.

As used herein, expressions such as “at least one of,” when preceding a list of elements, modify the entire list of elements and do not modify the individual elements of the list. For example, the expression, "at least one of a, b, and c," should be understood as including only a, only b, only c, both a and b, both a and c, both b and c, or all of a, b, and c.

In the following embodiments, the terms "first," "second," etc. are not used in a restrictive sense and are used to distinguish one element from another.

The singular forms as used herein are intended to include the plural forms as well unless the context clearly indicates otherwise.

It will be understood that the terms "include" and/or "comprise" used herein specify the presence of stated features or elements, but do not preclude the presence or addition of one or more other features or elements.

It will be understood that when an element or layer is referred to as being “over,” “above,” “on,” “below,” “under,” “beneath,” “connected to” or “coupled to” another element or layer, it can be directly over, above, on, below, under, beneath, connected or coupled to the other element or layer or intervening elements or layers may be present. In contrast, when an element is referred to as being “directly over,” “directly above,” “directly on,” “directly below,” “directly under,” “directly beneath,” “directly connected to” or “directly coupled to” another element or layer, there are no intervening elements or layers present.

In the following embodiments, it will be understood that the terms "connection" or "coupling" do not necessarily mean "direct and/or fixed connection or coupling" of two members, unless the context clearly indicates otherwise, and this does not preclude the disposition of other members between the two members.

Also, sizes of elements in the drawings may be exaggerated or reduced for convenience of explanation. For example, because sizes and/or thicknesses of elements in the drawings are arbitrarily illustrated for convenience of explanation, the disclosure is not limited thereto.

Furthermore, when a range is described in the embodiments, it includes the invention to which individual values within the range are applied (unless otherwise indicated herein). This is the same as stating each individual value constituting the above range in the detailed description.

Operations of a method may be performed in an appropriate order unless explicitly described in terms of order. In addition, the use of all illustrative terms (e.g., etc.) is merely for describing technical ideas in detail, and the scope is not limited by these examples or illustrative terms unless limited by the claims.

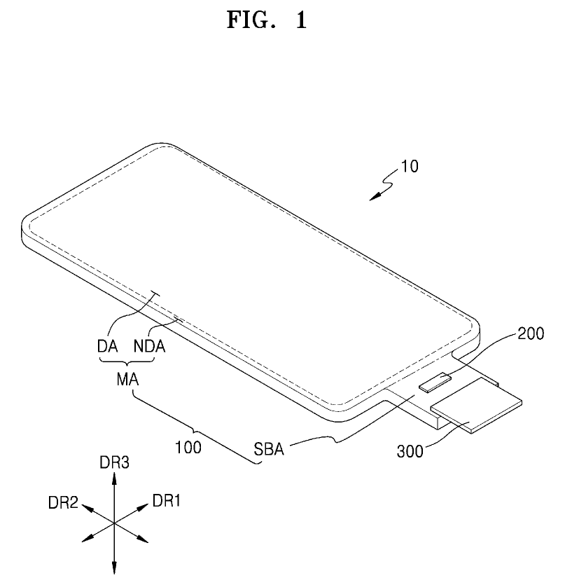

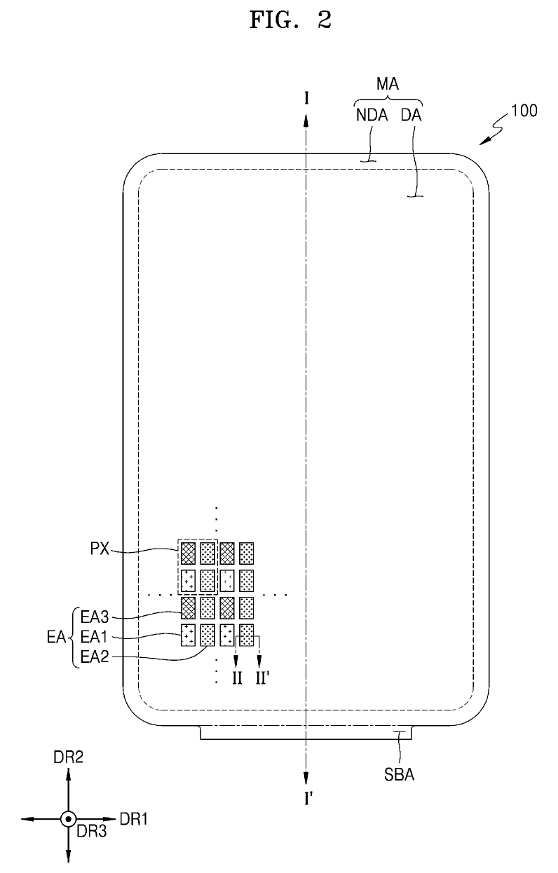

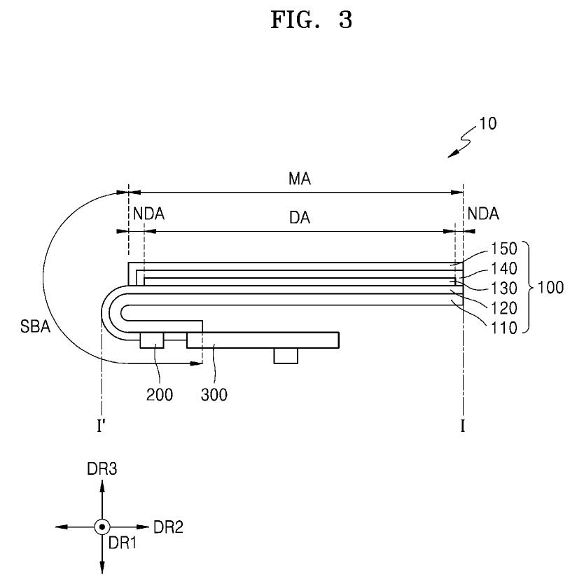

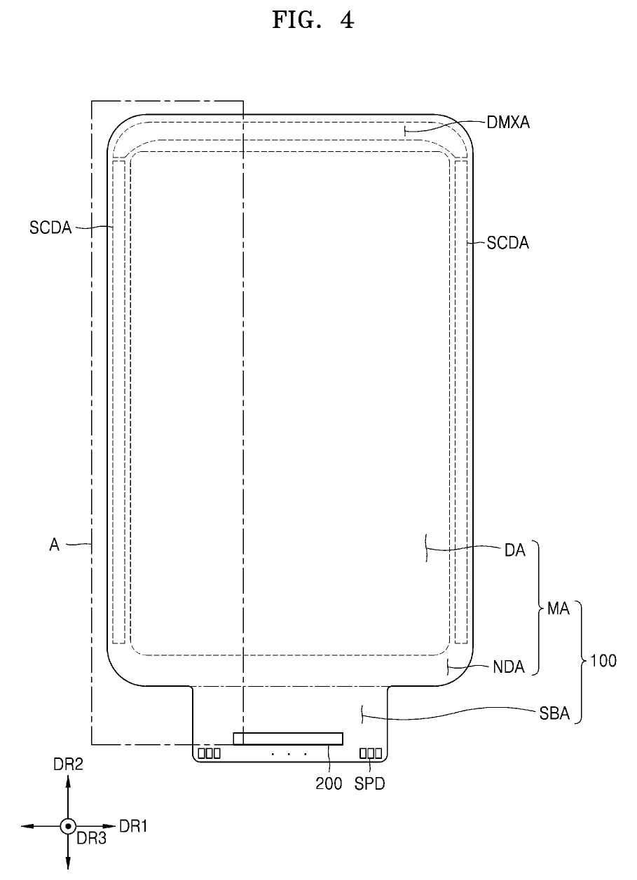

FIG. 1 is a perspective view illustrating a display device 10 according to an embodiment, FIG. 2 is a plan view illustrating the display device 10 of FIG. 1, FIG. 3 is a cross-sectional view illustrating an example of a surface taken along line I-I' of FIGS. 2, and FIG.4 is a plan view illustrating a main area and a sub-area in the display device 10 of FIG. 1.

Referring to FIG. 1, the display device 10 is a device which displays a moving image or a still image. The display device 10 may be used as a display screen of a portable electronic device, such as a mobile phone, smartphone, tablet personal computer (PC), smart watch, watch phone, mobile communication terminal, electronic organizer, e-book, portable multimedia player (PMP), navigation system, or ultra mobile PC (UMPC). Also, the display device 10 may be used as display screens of various products, such as a television, laptop, monitor, billboard, or Internet of things (IoT) device.

The display device 10 may be a light-emitting display device, such as an organic light-emitting display device using an organic light-emitting diode (LED), a quantum dot light-emitting display device including a quantum dot emission layer, an inorganic light-emitting display device including an inorganic semiconductor, and an ultra-small light-emitting display device using a micro LED or a nano LED. Hereinafter, a case where the display device 10 is an organic light-emitting display device is mainly described. However, the disclosure is not limited thereto and may be applied to a display device including an organic insulating material, an organic light-emitting material, and a metal material.

The display device 10 may be formed to be flat, but the disclosure is not limited thereto. For example, the display device 10 may include curved portions formed at the left and right ends and having a constant curvature or a varying curvature. In addition, the display device 10 may be formed flexibly to be foldable, twistable, bendable, or rollable.

The display device 10 may include a substrate (see 110 of FIG. 3), a display driving circuit 200, and a circuit board 300.

The substrate (see 110 of FIG. 3) may include a display area DA in which a plurality of emission areas (see EA of FIG. 2) configured to display an image are disposed.

In some embodiments, the substrate (see 110 of FIG. 3) may include a main area MA and a sub-area SBA. The main area MA may include the display area DA and a non-display area NDA around the display area DA. The sub-area SBA may protrude from a side of the main area MA in a second direction DR2.

FIGS. 1 and 4 illustrate a state where the sub-area SBA and the main area MA are unfolded side-by-side. In contrast, FIG. 2 illustrates a state where a portion of the sub-area SBA is bent.

Referring to FIG. 2, the display area DA may be formed as a rectangular plane having a short side in a first direction DR1 and a long side in a second direction DR2 intersecting the first direction DR1. Corners at which the short side in the first direction DR1 meets the long side in the second direction DR2 may be round to have a certain curvature, or may be at a right angle. The planar shape of the display area DA is not limited to the rectangular shape, and may be other polygonal, circular, or elliptical shapes.

The display area DA may occupy most of the main area MA. The display area DA may be disposed at the center of the main area MA.

The display area DA may include a plurality of emission areas EA disposed side-by-side. The display area DA may further include a non-emission area, which is a separation area between the plurality of emission areas EA.

The plurality of emission areas EA may be disposed side-by-side in the first direction DR1 and the second direction DR2.

Each of the plurality of emission areas EA may have a rhombic planar shape or a rectangular planar shape. However, this is only an example, and the planar shape of the plurality of emission areas EA according to an embodiment is not limited to that illustrated in FIG. 2. In some embodiments, the plurality of emission areas EA may have other planar shapes, for example, a polygonal shape other than the rectangular shape, a circular shape, or an elliptical shape.

The plurality of emission areas EA may include first emission areas EA1 configured to emit light of a first color in a certain wavelength band, second emission areas EA2 configured to emit light of a second color in a lower wavelength band than the first color, and third emission areas EA3 configured to emit light of a third color in a lower wavelength band than the second color.

For example, the first color may be red in a wavelength band of about 600 nm to about 750 nm. The second color may be green in a wavelength band of about 480 nm to about 560 nm. The third color may be blue in a wavelength band of about 370 nm to about 460 nm.

As illustrated in FIG. 2, the first emission areas EA1 and the third emission areas EA3 may be alternately disposed in the first direction DR1 or the second direction DR2. The second emission areas EA2 may be disposed side-by-side in the first direction DR1 or the second direction DR2.

Due to the plurality of emission areas EA, a plurality of pixels PX each configured to display luminance and a color may be provided. Each of the plurality of pixels PX may be a basic unit which displays various colors, including white, at a certain luminance.

Each of the plurality of pixels PX may include at least one first emission area EA1, at least one second emission area EA2, and at least one third emission area EA3, which are adjacent to each other.

Each of the plurality of pixels PX may display a color and luminance formed by a mixture of pieces of light emitted from the at least one first emission area EA1, the at least one second emission area EA2, and the at least one third emission area EA3, which are adjacent to each other.

FIG. 2 illustrates a case where the plurality of emission areas EA have the same area, but this is only an example. As another example, the third emission area EA3 may have the largest area, and the second emission area EA2 may have the smallest area.

FIG. 2 illustrates a case where the plurality of emission areas EA are disposed side-by-side in the first direction DR1 and the second direction DR2, but this is only an example. As another example, the second emission areas EA2 may be adjacent to the first emission area EA1 and the third emission area EA3 in a diagonal direction crossing the first direction DR1 and the second direction DR2.

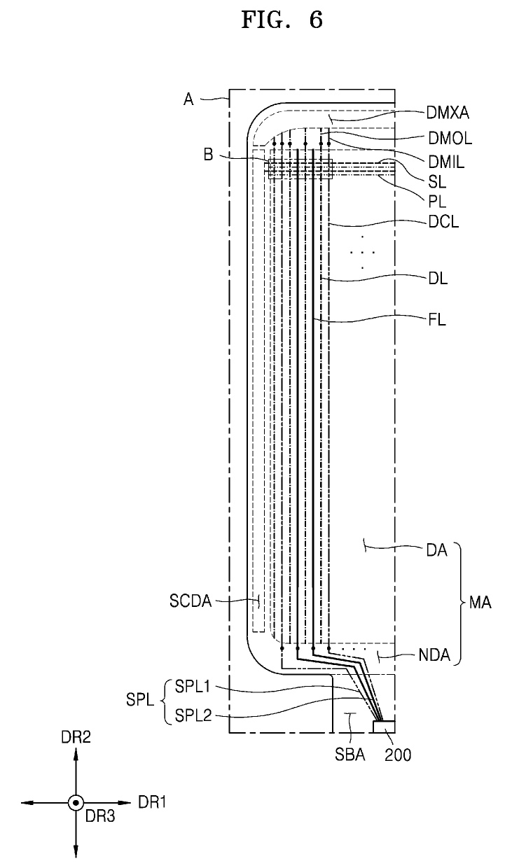

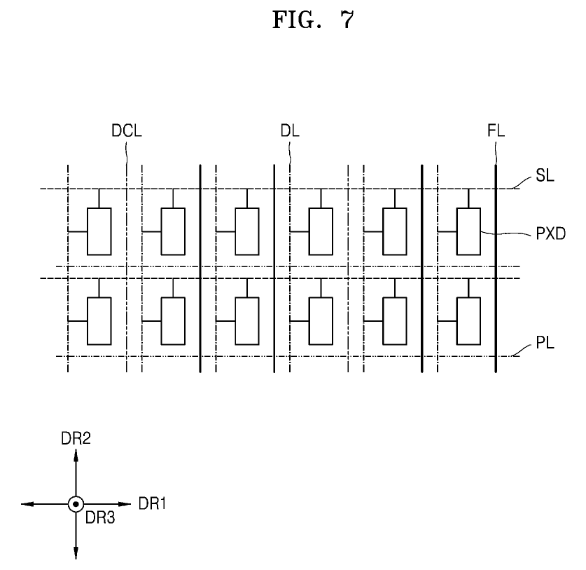

Referring to FIG. 3, a display panel 100 of the display device 10 may include a substrate 110 including a main area MA and a sub-area SBA, and a circuit array layer 120 disposed on the substrate 110. The circuit array layer 120 may include a plurality of pixel drivers (see PXD of FIG. 7) respectively corresponding to the plurality of emission areas EA, and data lines (see DL of FIG. 6) configured to respectively transmit data signals to the plurality of pixel drivers (see PXD of FIG. 7).

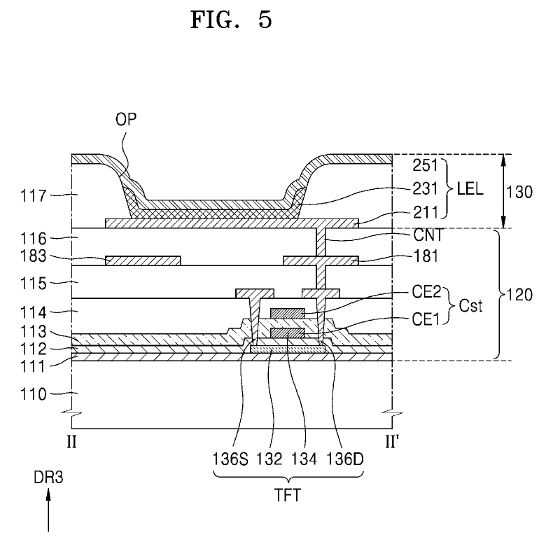

The display panel 100 of the display device 10 may further include an emission array layer 130 disposed on the circuit array layer 120. The emission array layer 130 may include a plurality of light-emitting elements (see LEL of FIG. 5) respectively corresponding to the plurality of emission areas EA.

The display panel 100 of the display device 10 may further include a sealing structure 140 covering the emission array layer 130 and a sensor electrode layer 150 disposed on the sealing structure 140.

The substrate 110 may include an insulating material such as polymer resin. For example, the substrate 110 may include polyimide. The substrate 110 may be a flexible substrate that is bendable, foldable, or rollable.

In other embodiments, the substrate 110 may include an insulating material such as glass.

The sealing structure 140 may be disposed on the circuit array layer 120, may correspond to the main area MA, and may cover the emission array layer 130. The sealing structure 140 may include a structure in which at least one inorganic layer and at least one organic layer are alternately stacked on the emission array layer 130.

The sensor electrode layer 150 may be disposed on the sealing structure 140 and may correspond to the main area MA. The sensor electrode layer 150 may include touch electrodes configured to sense a touch of a person or an object.

The display device 10 may further include a cover window disposed on the sensor electrode layer 150. The cover window may be attached to the sensor electrode layer 150 by a transparent adhesive member, such as an optically clear adhesive (OCA) film or an optically clear resin (OCR). The cover window may include an inorganic material such as glass, or may include an organic material such as plastic or a polymeric material. The cover window may protect the sensor electrode layer 150, the sealing structure 140, the emission array layer 130, and the circuit array layer 120 from electrical and/or physical impacts on the display surface.

In some embodiments, the display device 10 may further include an anti-reflection member disposed between the sensor electrode layer 150 and the cover window. The anti-reflection member may be a polarizing film or a color filter. Because the anti-reflection member blocks external light reflected from the sensor electrode layer 150, the sealing structure 140, the emission array layer 130, the circuit array layer 120, and the interfaces thereof, a reduction in visibility of images in the display device 10 may be prevented.

The display device 10 may further include a touch driving circuit configured to drive the sensor electrode layer 150.

The touch driving circuit may be provided as an integrated circuit (IC). The touch driving circuit may be mounted on the circuit board 300 bonded to signal pads SPD, so as to be electrically connected to the sensor electrode layer 150.

In some embodiments, similar to the display driving circuit 200, the touch driving circuit may be mounted in the sub-area SBA of the substrate 110.

The touch driving circuit may be configured to apply touch driving signals to a plurality of driving electrodes provided in the sensor electrode layer 150, to receive touch sensing signals of a plurality of touch nodes through a plurality of sensing electrodes, and to sense a charge change amount of mutual electrostatic capacitance based on the touch sensing signals.

In some embodiments, the touch driving circuit may be configured to determine the presence or absence of the touch or proximity of a user, based on the touch sensing signals of the plurality of touch nodes. The touch of the user refers to a direct contact of a user's finger or an object, such as a pen, with the front surface of the display device 10. The proximity of the user refers to hovering in which a user's finger or an object, such as a pen, is positioned away from the front surface of the display device 10.

Referring to FIG. 4, the display device may include a main area MA and a sub-area SBA. The main area MA may include a display area DA and a non-display area NDA. The non-display area NDA may include a demultiplexer (demux) area DMXA and a scan driving circuit area SCDA.

The main area MA may include the display area DA in which the plurality of emission areas EA are disposed in the first direction DR1 and the second direction DR2, and the non-display area NDA disposed around the display area DA.

Signal pads SPD and a display driving circuit 200 may be disposed in the sub-area SBA protruding from a side of the main area MA.

The display driving circuit 200 may be configured to generate signals and voltages for driving the pixel drivers (see PXD of FIG. 7) of the display area DA.

The display driving circuit 200 may be provided as an IC and mounted in the sub-area SBA of the substrate 110 through chip on glass (COG), chip on plastic (COP), or ultrasonic bonding, but the disclosure is not limited thereto. For example, the display driving circuit 200 may be attached to the circuit board 300 through chip on film (COF).

The circuit board 300 may be attached to and electrically connected to the signal pads SPD of the sub-area SBA by using a low-resistance, high-reliability material, such as an anisotropic conductive film or a silver adhesive paste (SAP).

The pixel drivers (see PXD of FIG. 7) and the display driving circuit 200 of the display area DA may be configured to receive digital video data, timing signals, and driving voltages from the circuit board 300.

The circuit board 300 may be a flexible printed circuit board, a printed circuit board, or a flexible film such as a chip on film.

The sub-area SBA may be disposed on a side of the main area MA, and the demux area DMXA may be disposed in the non-display area NDA on another side of the main area MA. That is, the sub-area SBA may be disposed on a first side of the main area MA, and the demux area DMXA may be disposed on a second side of the main area MA that is opposite to the first side in the second direction DR2.

The demux area DMXA may be disposed at least in the non-display area NDA between the display area DA and the end of the main area MA on the opposite side of the sub-area SBA. The demux area DMXA may extend from the non-display area NDA on the opposite side of the sub-area SBA to the non-display area NDA on the side surface.

Because the demux area DMXA is disposed on the opposite side of the display device from the sub-area SBA (i.e., the demux area DMXA may be on an opposite end of the display device with respect to the sub-area SBA in the second direction DR2), the areas of the sub-area SBA and the non-display area NDA adjacent to the sub-area SBA may be reduced. Furthermore, various types of lines and other components may be disposed in the sub-area SBA and the non-display area NDA adjacent to the sub-area SBA. Because the demux area DMXA is disposed on the opposite side of the display device from the sub-area SBA, a portion in which other lines and other components may be additionally disposed may be secured in the sub-area SBA and the non-display area NDA adjacent to the sub-area SBA.

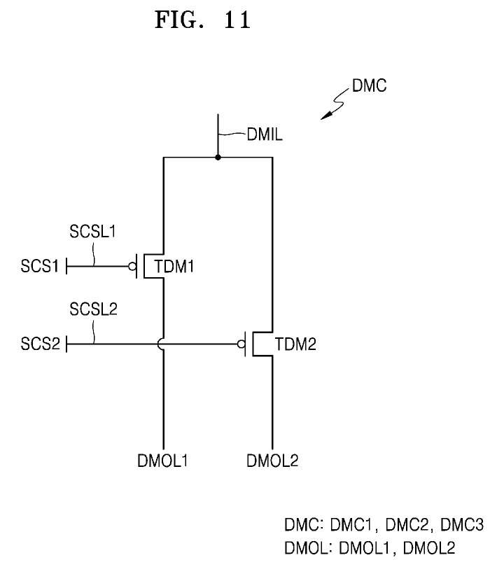

The circuit array layer 120 may include demux circuits (see DMC of FIG. 11) corresponding to the demux area DMXA.

The non-display area NDA may further include a scan driving circuit area SCDA disposed adjacent to at least one side of the display area DA in the first direction DR1.

The circuit array layer 120 may include a scan driving circuit corresponding to the scan driving circuit area SCDA. The scan driving circuit may be configured to supply scan signals to the scan lines SL disposed in the display area DA and extending in the first direction DR1.

For example, the display driving circuit 200 or the circuit board 300 may be configured to supply a scan control signal to the scan driving circuit, based on digital video data and timing signals.

The circuit board 300 may be configured to supply a certain constant voltage to the scan driving circuit so as to generate the scan signals.

FIG. 4 illustrates a case where the scan driving circuit area SCDA is a portion of the non-display area NDA adjacent to the display area DA in the first direction DR1 and on both sides of the display area DA (i.e., the scan driving circuit area SCDA may be referred to as two areas that are opposite each other in the first direction DR1 and adjacent to the display area DA), but this is only an example. The scan driving circuit area SCDA may be a portion of the non-display area NDA adjacent to any one side of the display area DA in the first direction DR1, or may be provided as divided areas overlapping portions of the display area DA.

The demux area DMXA may be a portion of the non-display area NDA opposite the sub-area SBA in the second direction DR2. The demux circuits (see DMC of FIG. 11) which connect the data lines DL of the display area DA to the display driving circuit 200 may be disposed in the demux area DMXA.

Each of the demux circuits (see DMC of FIG. 11) may be configured to output two or more data signals based on a single data driving signal.

For example, one of the demux circuits (see DMC of FIG. 11) may be configured to receive a single data driving signal from the display driving circuit 200 through an input terminal, to generate two or more data signals by time-demultiplexing the single data driving signal, and to output the two or more data signals through two or more output terminals respectively connected to two or more data lines DL during different periods.

The display driving circuit 200 disposed in the sub-area SBA of the substrate 110 may be configured to supply the corresponding data driving signals to the data lines DL. One of the demux circuits (see DMC of FIG. 11) may be configured to output two or more data signals based on the single data driving signal.

FIG. 5 is a cross-sectional view illustrating an example of a portion taken along line II-II' of FIG. 2.

Referring to FIG. 5, a buffer layer 111 may be disposed on a substrate 110 so as to prevent infiltration of impurities into a semiconductor layer of a thin-film transistor.

The substrate 110 may include various materials, such as glass, metal, or plastic. In an embodiment, the substrate 110 may be a flexible substrate. For example, the substrate 110 may include polymer resin, such as polyethersulfone (PES), polyacrylate (PAR), polyetherimide (PEI), polyethylene naphthalate (PEN), polyethylene terephthalate (PET), polyphenylene sulfide (PPS), polyarylate, polyimide (PI), polycarbonate, or cellulose acetate propionate (CAP).

The buffer layer 111 may include an inorganic insulating material, such as silicon nitride or silicon oxide, and may be a single layer or layers.

A thin-film transistor TFT, a capacitor Cst, and a light-emitting element LEL electrically connected to the thin-film transistor TFT may be disposed on the substrate 110. That is, a pixel electrode 211 may be electrically connected to the thin-film transistor TFT. The thin-film transistor TFT may be a driving transistor.

The thin-film transistor TFT may include a semiconductor layer 132, a gate electrode 134, a source electrode 136S, and a drain electrode 136D. The semiconductor layer 132 may include an oxide semiconductor material. The semiconductor layer 132 may include amorphous silicon, polycrystalline silicon, or an organic semiconductor material. The gate electrode 134 may include a single layer or layers including one or more materials selected from aluminum (Al), platinum (Pt), palladium (Pd), silver (Ag), magnesium (Mg), gold (Au), nickel (Ni), neodymium (Nd), iridium (Ir), chromium (Cr), lithium (Li), calcium (Ca), molybdenum (Mo), titanium (Ti), tungsten (W), and copper (Cu) by taking into account adhesion to adjacent layers, surface flatness of the stacked layers, and processability.

A gate insulating layer 112 including an inorganic material, such as silicon oxide, silicon nitride, and/or silicon oxynitride, may be disposed between the semiconductor layer 132 and the gate electrode 134. A first interlayer insulating layer 113 and a second interlayer insulating layer 114 each including an inorganic material, such as silicon oxide, silicon nitride, and/or silicon oxynitride, may be disposed between the gate electrode 134 and the source electrode 136S and between the gate electrode 134 and the drain electrode 136D. The source electrode 136S and the drain electrode 136D may be electrically connected to the semiconductor layer 132 through contact holes formed in the gate insulating layer 112, the first interlayer insulating layer 113, and the second interlayer insulating layer 114.

The source electrode 136S and the drain electrode 136D may each include a single layer or layers including one or more materials selected from aluminum (Al), platinum (Pt), palladium (Pd), silver (Ag), magnesium (Mg), gold (Au), nickel (Ni), neodymium (Nd), iridium (Ir), chromium (Cr), lithium (Li), calcium (Ca), molybdenum (Mo), titanium (Ti), tungsten (W), and copper (Cu).

The capacitor Cst may include a lower electrode CE1 and an upper electrode CE2 vertically arranged with the first interlayer insulating layer 113 therebetween. The first interlayer insulating layer 113 may be disposed between the lower electrode CE1 and the upper electrode CE2. The capacitor Cst may overlap the thin-film transistor TFT. In another embodiment, the capacitor Cst may not overlap the thin-film transistor TFT. The capacitor Cst may be covered by the second interlayer insulating layer 114.

A pixel circuit including the thin-film transistor TFT and the capacitor Cst may be covered by a first insulating layer 115 and a second insulating layer 116. The first insulating layer 115 and the second insulating layer 116 may each be an organic insulating layer which is a planarization insulating layer. The first insulating layer 115 and the second insulating layer 116 may each include an organic insulating material, for example, general-purpose polymer such as polymethylmethacrylate (PMMA) or polystyrene (PS), polymer derivatives having a phenolic group, acrylic-based polymer, imide-based polymer, aryl ether-based polymer, amide-based polymer, fluorine-based polymer, p-xylene-based polymer, vinyl alcohol-based polymer, and any blend thereof. In an embodiment, the first insulating layer 115 and the second insulating layer 116 may each include PI.

The display element, for example, the light-emitting element LEL may be disposed on the second insulating layer 116. The light-emitting element LEL may include a pixel electrode 211, an intermediate layer 231, and an opposite electrode 251.

The pixel electrode 211 may be disposed on the second insulating layer 116 and may be connected to the thin-film transistor TFT through a connection electrode 181 on the first insulating layer 115. Wirings 183, such as a data line DL and a power line PL, may be disposed on the first insulating layer 115.

The pixel electrode 211 may include a conductive oxide, such as indium tin oxide (ITO), indium zinc oxide (IZO), zinc oxide (ZnO), indium oxide (In₂O₃), indium gallium oxide (IGO), or aluminum zinc oxide (AZO). In another embodiment, the pixel electrode 211 may include a reflective layer including silver (Ag), magnesium (Mg), aluminum (Al), platinum (Pt), palladium (Pd), gold (Au), nickel (Ni), neodymium (Nd), iridium (Ir), chromium (Cr), or any compound thereof. In another embodiment, the pixel electrode 211 may further include a layer including ITO, IZO, ZnO, or In₂O₃ above and/or below the reflective layer.

A third insulating layer 117 may be disposed on the second insulating layer 116. The third insulating layer 117 may be a pixel defining layer which covers the edge of the pixel electrode 211 and defines a pixel by having an opening OP which exposes a portion of the pixel electrode 211.

The third insulating layer 117 may prevent an electric arc or the like from occurring on the edge of the pixel electrode 211 by increasing the distance between the edge of the pixel electrode 211 and the opposite electrode 251. The third insulating layer 117 may include, for example, an organic material, such as PI or hexamethyldisiloxane (HMDSO).

The intermediate layer 231 may include an emission layer. The emission layer may include a high molecular weight organic material or a low molecular weight organic material which emits light of a certain color. In an embodiment, the intermediate layer 231 may include a first functional layer disposed below the emission layer and/or a second functional layer disposed above the emission layer. The first functional layer and/or the second functional layer may include a layer which is integral across the plurality of pixel electrodes 211, or may include layers patterned to respectively correspond to the plurality of pixel electrodes 211.

The first functional layer may be a single layer or layers. For example, when the first functional layer includes a high molecular weight material, the first functional layer is a single-layered hole transport layer (HTL) and may include poly-(3,4)-ethylene-dihydroxy thiophene (PEDOT) or polyaniline (PANI). In case that the first functional layer includes a low molecular weight material, the first functional layer may include a hole injection layer (HIL) and an HTL.

The second functional layer may be omitted. For example, in case that the first functional layer and the emission layer each include a high molecular weight material, the second functional layer may be formed to improve characteristics of the organic LED. The second functional layer may be a single layer or layers. The second functional layer may include an electron transport layer (ETL) and/or an electron injection layer (EIL).

The opposite electrode 251 may be disposed to face the pixel electrode 211 with the intermediate layer 231. The intermediate layer 231 may be disposed between the opposite electrode 251 and the pixel electrode 211. The opposite electrode 251 may include a conductive material having a low work function. For example, the opposite electrode 251 may include a (semi)transparent layer including silver (Ag), magnesium (Mg), aluminum (Al), platinum (Pt), palladium (Pd), gold (Au), nickel (Ni), neodymium (Nd), iridium (Ir), chromium (Cr), lithium (Li), calcium (Ca), or any alloy thereof. In other embodiments, the opposite electrode 251 may further include a layer including ITO, IZO, ZnO, or In₂O₃ on the (semi)transparent layer including the material described above.

The opposite electrode 251 may be disposed on the intermediate layer 231 and the third insulating layer 117. The opposite electrode 251 may be formed integrally with a plurality of light-emitting elements LEL in the display area DA and may be opposite the plurality of pixel electrodes 211.

A sealing structure 140 may be disposed on the opposite electrode 251 as an encapsulation member. The sealing structure 140 may protect the light-emitting element LEL from ambient moisture or oxygen. The sealing structure 140 may have a multilayer structure.

Functional layers, such as a sensor electrode layer 150, a refractive layer, a polarizing layer, or a window, may be disposed on the light-emitting element LEL, for example, on the sealing structure 140.

FIG. 6 is a layout diagram illustrating region A of FIG. 4, according to an embodiment, and FIG. 7 is an enlarged view illustrating region B of FIG. 6, according to an embodiment.

FIGS. 6 and 7 illustrate a case where the demux circuit (see DMC of FIG. 11) according to an embodiment is connected to three data lines DL. However, the disclosure is not limited thereto. The demux circuit (see DMC of FIG. 11) may be connected to two data lines DL or four or more data lines DL.

The circuit array layer 120 may further include spider lines SPL extending from the display driving circuit 200, and demux connection lines DCL respectively connected to first spider lines SPL1 among the spider lines SPL.

The spider lines SPL may include the first spider lines SPL1 electrically connected to the demux circuit (see DMC of FIG. 11) and second spider lines SPL2 connected to floating lines FL.

The spider lines SPL may extend from the display driving circuit 200, may pass through the sub-area SBA, and may extend up to the non-display area NDA. The spider lines SPL may be electrically connected to the display driving circuit 200, and the first spider lines SPL1 may be electrically connected to the corresponding data lines DL.

The first spider lines SPL1 may be configured to respectively transmit data signals from the display driving circuit 200 to the corresponding data lines DL.

The data signals from the display driving circuit 200 may be transmitted to the pixel driver PXD through the data lines DL, the demux circuit (see DMC of FIG. 11), and the first spider lines SPL1.

As an example, the first spider lines SPL1 and the data lines DL may have a 1:3 correspondence. However, the disclosure is not limited thereto, and the first spider lines SPL1 and the data lines DL may have a 1:n correspondence (where n is an integer), unlike in FIGS. 6 and 7.

As an example, the demux area DMXA may be disposed on the opposite side of the non-display area NDA from where the display driving circuit 200 is disposed. However, the disclosure is not limited thereto, and the demux area DMXA may be disposed between the non-display area NDA where the display driving circuit 200 is disposed and the opposite side of the non-display area NDA where the display driving circuit 200 is disposed, or may extend from the opposite side of the non-display area NDA where the display driving circuit 200 is disposed toward the non-display area NDA where the display driving circuit 200 is disposed. That is, the demux area DMXA may be disposed relatively adjacent to the display driving circuit 200, as well as on the non-display area NDA that is opposite to the display area DA in the first direction DR1.

The demux connection line DCL connecting the first spider line SPL1 to the demux area DMXA may be applied so that the first spider line SPL1 may be electrically connected to the data line DL through the demux circuit (see DMC of FIG. 11). The demux connection line DCL may be disposed to pass through at least a portion of the display area DA.

The first spider line SPL1 may be connected to the demux connection line DCL which is directed to the demux area DMXA through the display area DA. At least a portion of the demux connection line DCL may extend from the display area DA in the second direction DR2.

However, the disclosure is not limited thereto. The demux connection line DCL may extend in the second direction DR2 within the display area DA, extend in the first direction DR1, and then extend again in the second direction DR2, so as to be directed toward the demux area DMXA. In this case, when the demux connection line DCL extends while changing a direction, a cut may be made between the demux connection line DCL and other lines at a point where the direction of the demux connection line DCL is changed so as not to overlap the other lines.

A single demux connection line DCL may correspond to a plurality of data lines DL. For example, the demux connection lines DCL and the data lines DL may have a 1:3 correspondence. However, the disclosure is not limited thereto. The demux connection lines DCL and the data lines DL may have a 1:n correspondence (where n is an integer).

The demux connection line DCL may extend from the display area DA toward the demux area DMXA. Although FIGS. 6 and 7 illustrate that one demux connection line DCL is disposed between the pixel drivers PXD, the disclosure is not limited thereto, and a plurality of demux connection lines DCL may be disposed between the pixel drivers PXD.

The second spider line SPL2 may be connected to the floating line FL directed from the display area DA toward the demux area DMXA. The floating line FL may extend from the display area DA in the second direction DR2, i.e., toward the demux area DMXA.

However, the disclosure is not limited thereto. The floating line FL may extend in the second direction DR2 within the display area DA, extend in the first direction DR1, and then extend again in the second direction DR2, so as to be directed toward the demux area DMXA.

The floating line FL may not be connected to the demux circuit (see DMC of FIG. 11). The floating line FL may not be connected to the data line DL. As an example, the floating line FL may be in a floating state of not being connected to other lines. The floating line FL may be, for example, a line to which no signal is applied.

All or a portion of the floating line FL may be, for example, a line configured to apply a voltage to the pixel driver PXD. In other words, the floating line FL may act as the power line PL. The floating line FL may be connected to the power line PL configured to supply any one of types of power supply voltage. The floating line FL may be, for example, a power auxiliary line electrically connected to the power line PL. In this case, because the floating line FL is connected to another power line PL, the load of the power supply may be reduced, and thus, the heat generation of the display device 10 may be reduced.

As an example, all or a portion of the floating line FL may also be used as another type of line configured to perform a function other than the function of the power line PL.

The circuit array layer 120 may include demux input lines DMIL which respectively connect the demux connection lines DCL to the demux circuit (see DMC of FIG. 11), and demux output lines DMOL which respectively connect the demux circuit (see DMC of FIG. 11) to the data lines DL.

One of the demux input lines DMIL may correspond to the plurality of demux output lines DMOL. For example, the demux input lines DMIL and the demux output lines DMOL may have a 1:3 correspondence. However, the disclosure is not limited thereto. The demux input lines DMIL and the demux output lines DMOL may have a 1:n correspondence (where n is an integer).

Although FIG. 6 illustrates that the demux connection line DCL and the demux input line DMIL are connected to each other as different lines, the demux connection line DCL and the demux input line DMIL may be a single line.

Although FIG. 6 illustrates that the data line DL and the demux output line DMOL are connected to each other as different lines, the data line DL and the demux output line DMOL may be a single line.

The non-display area NDA may further include a scan driving circuit area SCDA disposed adjacent to at least one side of the display area DA in the first direction DR1. The circuit array layer 120 may include a scan driving circuit corresponding to the scan driving circuit area SCDA.

The circuit array layer 120 may further include scan lines SL extending in the first direction DR1 and configured to transmit scan signals to the plurality of pixel drivers PXD.

The scan driving circuit may be configured to supply the scan signals to the scan lines SL.

The scan lines SL may cross the data lines DL. That is, the scan lines SL may cross over the data lines DL in a direction perpendicular to the extension direction of the data lines DL. As shown in FIG. 6, the data lines DL may extend in the first direction DR1, and the scan lines SL may cross the data lines DL in the second direction DR2. The scan lines SL may be connected to the pixels PX.

The scan lines SL may include, for example, a write scan line GWL, an initialization scan line GIL, a control scan lines GCL, and an emission control line ECL.

The circuit array layer 120 may further include a power line PL extending from the display area DA in the first direction DR1.

The power line PL may be configured to supply the power supply voltage to the plurality of pixels PX. The power supply voltage may be at least one of a first power supply voltage ELVDD, a second power supply voltage ELVSS, a first initialization voltage VINT, or a second initialization voltage VAINT.

The power line PL may include a first power line VDL configured to supply the first power supply voltage ELVDD, a second power line VSL configured to supply the second power voltage ELVSS, a gate initialization voltage line VGIL configured to supply the first initialization voltage VINT, and an anode initialization voltage line VAIL configured to supply the second initialization voltage VAINT.

The type and number of scan lines SL and power lines PL connected to the plurality of pixels PX are not limited to those described above and may vary depending on the structure of the pixel PX.

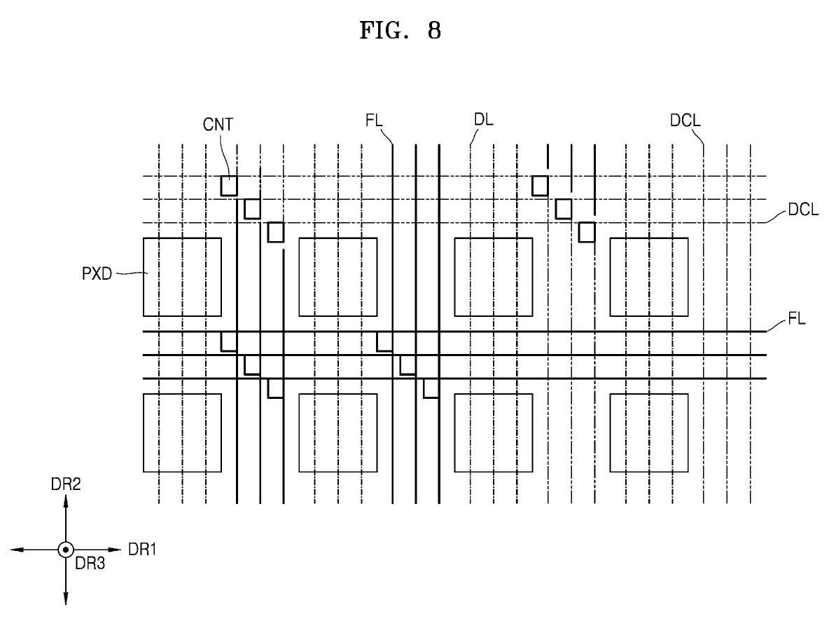

FIG. 8 is an enlarged view illustrating a portion of the display area DA according to an embodiment. FIG. 8 schematically illustrates a portion of the display area DA in an example of the display device 10 in which the demux connection lines DCL and the data lines DL have a 1:2 correspondence.

The demux connection line DCL may be a line applied in case that the demux area DMXA where the demux circuit (see DMC of FIG. 11) is disposed is not disposed in the sub-area SBA where the display driving circuit 200 is disposed, and is disposed in the non-display area NDA that is spaced apart from the sub-area SBA. In FIG. 4, because the demux area DMXA is disposed at the upper end or the side end of the display device 10 spaced apart from the sub-area SBA in the second direction DR2 or the first direction DR1, the demux connection line DCL which electrically connects the demux circuit (see DMC of FIG. 11) to the display driving circuit 200 may be disposed to pass through a portion of the display area DA.

The demux connection line DCL extending in the second direction DR2 and the demux connection line DCL extending in the first direction DR1 may be disposed on different layers, and the demux connection line DCL extending in the second direction DR2 and the demux connection line DCL extending in the first direction DR1 may be electrically connected to each other at a contact portion CNT. In other words, due to the contact portion CNT, signals may be transmitted through the demux connection lines DCL, regardless of a portion where the demux area DMXA is disposed.

Lines may be disposed to correspond to the pixel drivers PXD. Some lines may be used as the demux connection lines DCL, and the remaining lines which are not used as the demux connection lines DCL may be used as the floating lines FL. As described with reference to FIGS. 6 and 7, the floating lines FL may be in a floating state and may act as the power lines PL.

The floating lines FL may include a floating line FL extending in the second direction DR2 and a floating line FL extending in the first direction DR1, which are disposed on different layers. The floating line FL extending in the second direction DR2 and the floating line FL extending in the first direction DR1 may be electrically connected to each other at the contact portion CNT.

Some of the lines extending in the second direction DR2 may be the floating lines FL, and some of the lines extending in the second direction DR2 may be the demux connection lines DCL. In this case, a portion between the floating line FL and the demux connection line DCL may be cut.

The demux connection line DCL may extend to the demux circuit (see DMC of FIG. 11) of the demux area DMXA, and the data lines DL that are an integer multiple of the number of demux connection lines DCL may extend from the demux circuit (see DMC of FIG. 11) to the pixel driver PXD. As described with reference to FIG. 6, the demux input line DMIL may be disposed between the demux connection line DCL and the demux circuit (see DMC of FIG. 11), and the demux output line DMOL may be disposed between the data line DL and the demux circuit (see DMC of FIG. 11).

The configuration and effects of the display device 10 of FIGS. 6 and 7 may be applied to the display device 10 of FIG. 8 within the range which does not conflict with the description provided above.

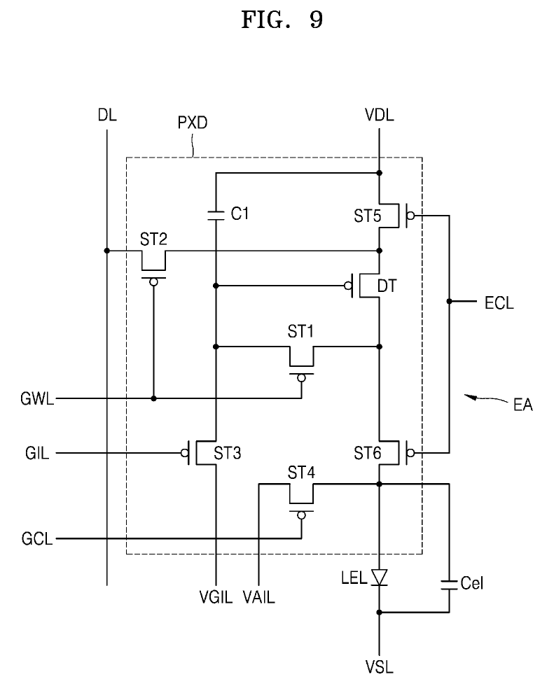

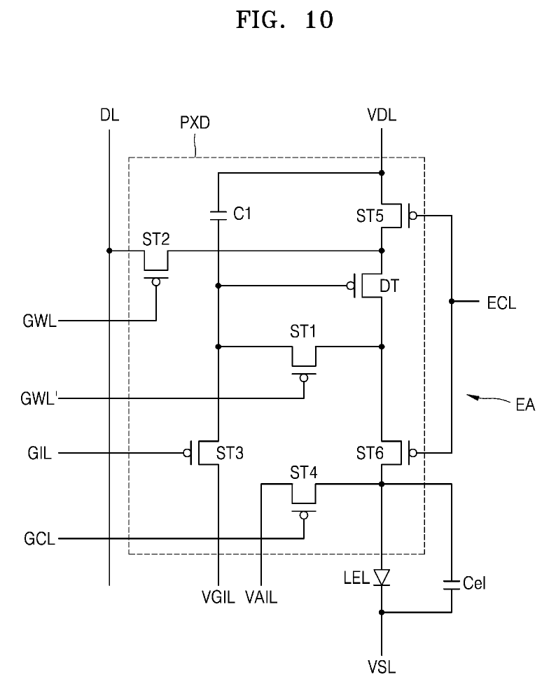

FIG. 9 is an equivalent circuit diagram of an example of the pixel driver of FIG. 7, and FIG. 10 is an equivalent circuit diagram of another example of the pixel driver of FIG. 7.

The circuit array layer 120 may include a plurality of pixel drivers PXD respectively corresponding to a plurality of emission areas EA. The plurality of pixel drivers PXD may be configured to supply a driving current to each of the plurality of emission elements LEL provided in the emission array layer 130.

Each of the plurality of pixel drivers PXD may include a driving transistor DT, at least one switching element, and at least one capacitor.

Referring to FIG. 9, one of the plurality of pixel drivers PXD provided in the circuit array layer 120 may include the driving transistor DT, switching elements including a first transistor (a switch transistor) ST1, a second transistor ST2, a third transistor ST3, a fourth transistor ST4, a fifth transistor ST5, and a sixth transistor ST6, and a capacitor C1.

Scan lines SL of the circuit array layer 120 connected to a scan driving circuit of a scan driving circuit area SCDA may include a write scan line GWL connected to the gate electrode 134 of each of the first transistor ST1 and the second transistor ST2, an initialization scan line GIL connected to the gate electrode 134 of the third transistor ST3, a control scan line GCL connected to the gate electrode 134 of the fourth transistor ST4, and an emission control line ECL connected to the gate electrode 134 of each of the fifth transistor ST5 and the sixth transistor ST6.

The driving transistor DT may be connected in series to a light-emitting element LEL between a first power line VDL and a second power line VSL.

A first electrode of the driving transistor DT may be connected to the first power line VDL through the fifth transistor ST5.

The first electrode of the driving transistor DT may be connected to the data line DL through the second transistor ST2.

A second electrode of the driving transistor DT may be connected to the light-emitting element LEL through the sixth transistor ST6.

The capacitor C1 may be connected between the first power line VDL and the gate electrode 134 of the driving transistor DT. In some embodiments, the gate electrode 134 of the driving transistor DT may be connected to the first power line VDL through the capacitor C1.

Accordingly, when the data signal of the data line DL is applied to the first electrode of the driving transistor DT, the driving transistor DT may generate a drain-source current corresponding to the data signal. The drain-source current of the driving transistor DT may be supplied as the driving current of the light-emitting element LEL.

The light-emitting element LEL may be configured to emit light with a luminance corresponding to the driving current supplied by the driving transistor DT.

The light-emitting element LEL may include a pixel electrode 211 and an opposite electrode 251 facing each other, and an intermediate layer 231 between the pixel electrode 211 and the opposite electrode 251.

For example, the light-emitting element LEL may be an organic LED including an emission layer including an organic light-emitting material. In other embodiments, the light-emitting element LEL may be an inorganic light-emitting element including an emission layer including an inorganic semiconductor. In other embodiments, the light-emitting element LEL may be a quantum dot light-emitting element including a quantum dot emission layer. In other embodiments, the light-emitting element LEL may be a micro LED.

A capacitor Cel connected in parallel to the light-emitting element LEL may form a parasitic capacitance between the pixel electrode 211 and the opposite electrode 251.

The first transistor ST1 may be connected between the gate electrode of the driving transistor DT and the second electrode of the driving transistor DT.

The first transistor ST1 may be connected between the gate electrode of the driving transistor DT and the second electrode of the driving transistor DT.

The second transistor ST2 may be connected between the first electrode of the driving transistor DT and the data line DL.

The gate electrodes of each of the first transistor ST1 and the second transistor ST2 may be connected to the write scan line GWL.

When a write scan signal is supplied through the write scan line GWL, the first transistor ST1 and the second transistor ST2 may be turned on, and the gate electrode 134 and the second electrode of the driving transistor DT may have the same potential through the turned-on first transistor ST1. The data signal of the data line DL may be supplied to the first electrode of the driving transistor DT through the turned-on second transistor ST2.

In this case, in case that the voltage difference between the first electrode and the gate electrode 134 of the driving transistor DT is greater than a threshold voltage, the driving transistor DT may be turned on and the drain-source current may be generated between the first electrode and the second electrode of the driving transistor DT.

The third transistor ST3 may be connected between the gate electrode 134 of the driving transistor DT and the gate initialization voltage line VGIL. The gate electrode 134 of the third transistor ST3 may be connected to the initialization scan line GIL.

In case that an initialization scan signal is supplied through the initialization scan line GIL, the third transistor ST3 may be turned on. In this case, the gate electrode 134 of the driving transistor DT may be connected to the gate initialization voltage line VGIL through the turned-on third transistor ST3, and thus, the potential of the gate electrode 134 of the driving transistor DT may be initialized to the first initialization voltage VINT of the gate initialization voltage line VGIL.

The fourth transistor ST4 may be connected between the pixel electrode 211 of the light-emitting element LEL and the anode initialization voltage line VAIL. The gate electrode 134 of the fourth transistor ST4 may be connected to the control scan line GCL.

In case that a control scan signal is supplied through the control scan line GCL, the fourth transistor ST4 may be turned on. In this case, the pixel electrode 211 of the light-emitting element LEL may be connected to the anode initialization voltage line VAIL through the turned-on fourth transistor ST4, and thus, the potential of the pixel electrode 211 of the light-emitting element LEL may be initialized to the second initialization voltage VAINT of the anode initialization voltage line VAIL.

The fifth transistor ST5 may be connected between the first electrode of the driving transistor DT and the first power line VDL.

The sixth transistor ST6 may be connected between the second electrode of the driving transistor DT and the pixel electrode 211 of the light-emitting element LEL.

The gate electrode 134 of each of the fifth transistor ST5 and the sixth transistor ST6 may be connected to the emission control line ECL.

In case that an emission control signal is supplied through the emission control line ECL, the driving transistor DT and the light-emitting element LEL may be connected in series between the first power line VDL and the second power line VSL, and thus, the light-emitting element LEL may emit light based on the driving current supplied by the driving transistor DT.

As illustrated in FIG. 9, the driving transistor DT and at least one of the switching elements ST1 to 6, which are provided in the pixel driver PXD, may be provided as P-type metal-oxide semiconductor field effect transistors (MOSFETs). In this case, each of the scan lines GWL, GIL, GCL, and ECL may be configured to supply a low-level turn-on signal.

In other embodiments, some of the driving transistor DT and at least one of the switching elements ST1 to 6, which are provided in the pixel driver PXD, may be provided as P-type metal-oxide-semiconductor (MOS) field effect transistors (FETs) (MOSFETs), and the others may be provided as an N-type MOSFETs. In this case, the switching elements provided as P-type MOSFETs and the switching elements provided as N-type MOSFETs may include active layers including different semiconductor materials. Therefore, the width of the pixel driver PXD may be reduced through the stacked structure, which may be advantageous for improving resolution.

As illustrated in FIG. 10, according to another example, a pixel driver PXD may include a driving transistor DT and at least one switching element ST1 to ST6. The driving transistor DT, the second transistor ST2, the fourth transistor ST4, the fifth transistor ST5, and the sixth transistor ST6 may be provided as P-type MOSFETs each including an active layer including a polysilicon semiconductor material, and the first transistor ST1 and the third transistor ST3 may be provided as N-type MOSFETs each including an active layer including an oxide semiconductor material.

In this case, unlike the second transistor ST2, the first transistor ST1 may be turned on in response to a high-level turn-on signal. Accordingly, the gate electrode 134 of the first transistor ST1 may be connected to a separate additional write scan line GWL' rather than a write scan line GWL.

According to another example, the first transistor ST1, the third transistor ST3, and the fourth transistor ST4 among the switching elements ST1 to 6 may be provided as N-type MOSFETs. In this case, the control scan line GCL may be configured to transmit a high-level turn-on signal.

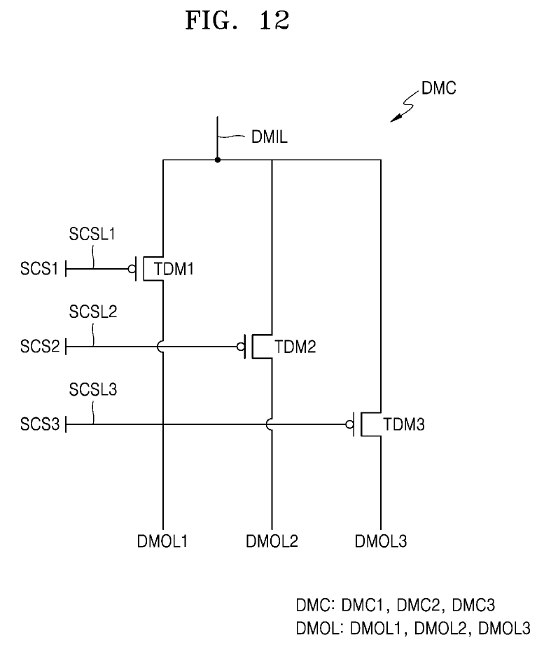

FIG. 11 is an equivalent circuit diagram of a demux circuit DMC according to an embodiment, and FIG. 12 is an equivalent circuit diagram of a demux circuit DMC according to an embodiment.

FIG. 11 illustrates a case where the demux circuit DMC according to an embodiment is connected to two data lines DL. Demux circuits DMC of FIG. 11 may be applied to, for example, the display device of FIG. 8 in which each of the demux circuits DMC corresponds to two output terminals.

As illustrated in FIG. 11, one of the demux circuits DMC according to an embodiment may include two demux transistors TDM1 and TDM2 respectively corresponding to two output terminals.

First electrodes (e.g., source electrodes) of the two demux transistors TDM1 and TDM2 may be connected to a demux input line DMIL.

Second electrodes (e.g., drain electrodes) of the two demux transistors TDM1 and TDM2 may be respectively connected to a first demux output line DMOL1 and a second demux output line DMOL2.

In other words, in the case of the first demux circuit DMC1, the second electrode of the first demux transistor TDM1 may be connected to the first data line DL1 through the first demux output line DMOL1, and the second electrode of the second demux transistor TDM2 may be connected to the second data line DL2 through the second demux output line DMOL2.

In the case of the second demux circuit DMC2, the second electrode of the first demux transistor TDM1 may be connected to the third data line DL3 through the first demux output line DMOL1, and the second electrode of the second demux transistor TDM2 may be connected to the fourth data line DL4 through the second demux output line DMOL2.

The gate electrode of the first demux transistor TDM1 may be connected to a first demux control line SCSL1, and the gate electrode of the second demux transistor TDM2 may be connected to a second demux control line SCSL2.

The first demux control line SCSL1 and the second demux control line SCSL2 may be configured to respectively transmit a first demux control signal SCS1 and a second demux control signal SCS2 having different phases.

The first demux transistor TDM1 and the second demux transistor TDM2 may be respectively turned on during different periods in response to the first demux control signal SCS1 and the second demux control signal SCS2 having different phases.

Therefore, the data driving signal of the display driving circuit 200 transmitted through the demux input line DMIL may be demultiplexed in a time division manner by the first demux transistor TDM1 and the second demux transistor TDM2, which are turned on during different periods. Accordingly, the data signal may be transmitted during different periods to the first data line DL1 and the second data line DL2 connected to the output terminals of the demux circuit DMC.

FIG. 12 illustrates a case where the demux circuit DMC according to an embodiment is connected to three data lines DL. Demux circuits DMC of FIG. 12 may be applied to, for example, the display device of FIG. 7 in which each of the demux circuits DMC corresponds to three output terminals.

A display device of FIG. 12 according to an embodiment is substantially the same as the display device of FIG. 11 according to an embodiment, except that each of the demux circuits DMCs includes three output terminals instead of two output terminals, and therefore, a redundant description thereof is omitted below.

Referring to FIG. 12, the demux circuit DMC according to an embodiment may include a first demux transistor TDM1 connected between a demux input line DMIL and a first demux output line DMOL1, a second demux transistor TDM2 connected between the demux input line DMIL and a second demux output line DMOL2, and a third demux transistor TDM3 connected between the demux input line DMIL and a third data output line DMOL3.

For example, first electrodes (e.g., source electrodes) of the first demux transistor TDM1, the second demux transistor TDM2, and the third demux transistor TDM3 may each be connected to the demux input line DMIL. Second electrodes (e.g., drain electrodes) of the first demux transistor TDM1, the second demux transistor TDM2, and the third demux transistor TDM3 may be respectively connected to demux output lines DMOL.

A gate electrode of the first demux transistor TDM1 may be connected to a first demux control line SCSL1 configured to transmit a first demux control signal SCS1.

A gate electrode of the second demux transistor TDM2 may be connected to a second demux control line SCSL2 configured to transmit a second demux control signal SCS2 having a phase that is different from a phase of the first demux control signal SCS1.

A gate electrode of the third demux transistor TDM3 may be connected to a third demux control line SCSL3 configured to transmit a third demux control signal SCS3 having a phase that is different from a phase of the first demux control signal SCS1 and a phase of the second demux control signal SCS2.

However, the embodiments of FIGS. 11 and 12 are only examples, and each of the demux circuits DMC may be connected to four or more data lines within the range which enables data driving signals to be generated.

The display device 10 according to an embodiment may be applied to various electronic devices. An electronic device according to an embodiment may include the display device 10 described above, and may further include, in addition to the display device 10, a module or a device having additional functions.

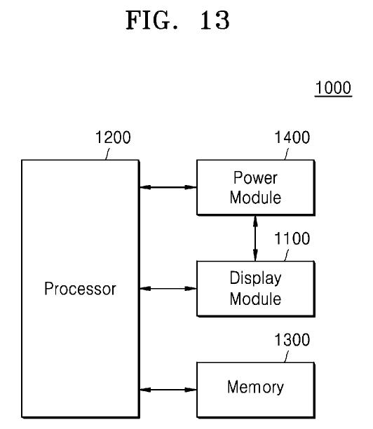

FIG. 13 is a block diagram of an electronic device 1000 according to an embodiment. Referring to FIG. 13, the electronic device 1000 according to an embodiment may include a display module 1100, a processor 1200, a memory 1300, and a power module 1400.

The processor 1200 may include at least one of a central processing unit (CPU), an application processor (AP), a graphics processing unit (GPU), a communication processor (CP), an image signal processor (ISP), or a controller.

Data information necessary for the operation of the processor 1200 or the display module 1100 may be stored in the memory 1300. In case that the processor 1200 executes an application stored in the memory 1300, an image data signal and/or an input control signal may be transmitted to the display module 1100, and the display module 1100 may process the received signals and output image information on a display screen.

The power module 1400 may include a power supply module, such as a power adapter or a battery device, and a power conversion module which converts power supplied by the power supply module and generate power necessary for the operation of the electronic device 1000.

At least one of components of the electronic device 1000 may be included in the display device 10 according to the embodiments described above. Furthermore, some of the individual modules functionally included in a single module may be included in the display device, and others may be provided separately from the display device. For example, the display device 10 may include the display module 1100, and the processor 1200, the memory 1300, and the power module 1400 may be provided in the form of other devices in the electronic device 1000 other than the display device 10.

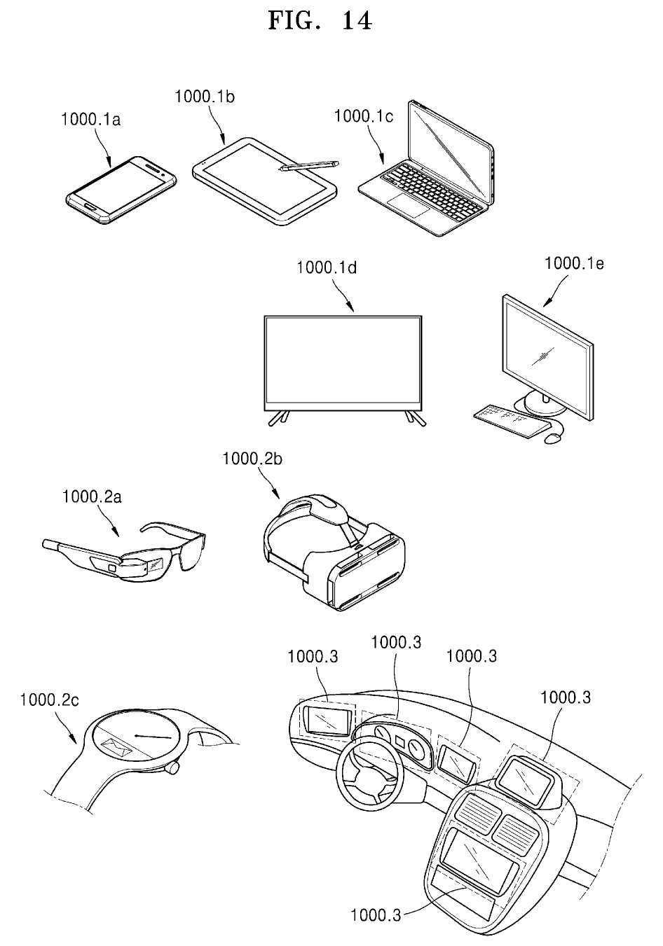

FIG. 14 is a schematic diagram of electronic devices according to various embodiments.

Referring to FIG. 14, various electronic devices to which the display device 10 according to embodiments is applied may include image display electronic devices, such as a smartphone 1000.1a, a tablet personal computer (PC) 1000.1b, a laptop 1000.1c, a television (TV) 1000.1d, or a desk monitor 1000.1e, wearable electronic devices including display modules, such as smart glasses 1000.2a, a head mounted display 1000.2b, or a smart watch 1000.2c, and vehicle electronic devices 1000.3 including display modules, such as a dashboard of an automobile, center information display (CID) on center fascia or dashboard, or a room mirror display.

One or more embodiments include a display device in which a demux area is disposed on an opposite side of a display driving circuit so that a non-display area around the display driving circuit is reduced, and an electronic device including the display device. That is, in a conventional display device, the demux area is disposed on the same side as the sub-area, increasing the size of the bottom border of the display device. Thus, by providing the demux area and a sub-area, spaced apart from each other and on opposite sides of a main display area of the display device, and subsequently running data lines and floating lines connecting spider lines in the sub-area to the data lines and floating lines and then to the demux area, the demux area may be positioned elsewhere in the display device, allowing the area/size of the bottom border (or other border with the corresponding sub-area) to be reduced.

Each of the embodiments provided in the above description is not excluded from being associated with one or more features of another example or another embodiment also provided herein or not provided herein but consistent with the disclosure.

While the disclosure has been particularly shown and described with reference to embodiments thereof, it will be understood that various changes in form and details may be made therein without departing from the spirit and scope of the following claims.

What is claimed is:

1. A display device comprising:
a substrate comprising a main area and a sub-area extending from a side of the main area, the main area comprising a display area in which a plurality of emission areas are disposed in a first direction and a second direction, and a non-display area around the display area;
a circuit array layer on the substrate and comprising a plurality of pixel drivers respectively corresponding to the plurality of emission areas, data lines configured to transmit a data signal to the plurality of pixel drivers, and demultiplexer (demux) circuits in a demux area that is in the non-display area; and
a display driving circuit in the sub-area of the substrate and configured to supply corresponding data driving signals to the data lines,
wherein one of the demux circuits is configured to output two or more data signals based on one of the data driving signals,
wherein the circuit array layer comprises spider lines comprising first spider lines and extending from the display driving circuit, and demux connection lines respectively connected to the first spider lines, and
wherein one of the demux connection lines corresponds to a plurality of data lines among the data lines.

2. The display device of claim 1, wherein the demux area is on a first side of the non-display area, and
wherein the display driving circuit is on a second side of the non-display area that is opposite to the first side in the second direction.

3. The display device of claim 1, wherein the spider lines further comprise second spider lines connected to a floating line.

4. The display device of claim 3, wherein the floating line is in a floating state.

5. The display device of claim 3, wherein the floating line comprises a line configured to apply a voltage to the plurality of pixel drivers.

6. The display device of claim 1, wherein each of the demux connection lines extends from the display area toward the demux area.

7. The display device of claim 1, wherein the circuit array layer further comprises:
demux input lines respectively connecting the demux connection lines to the demux circuits; and
demux output lines respectively connecting the demux circuits to the data lines, and
wherein one of the demux input lines corresponds to a plurality of demux output lines among the demux output lines.

8. The display device of claim 1, wherein the circuit array layer further comprises scan lines extending in the first direction and configured to transmit a scan signal to the plurality of pixel drivers.

9. The display device of claim 8, wherein the scan lines cross the data lines.

10. The display device of claim 8, wherein the non-display area comprises a scan driving circuit area adjacent to at least one side of the display area in the first direction,
wherein the circuit array layer further comprises a scan driving circuit corresponding to the scan driving circuit area, and
wherein the scan driving circuit is configured to respectively supply scan signals to the scan lines.

11. A display device comprising:
a substrate comprising a main area and a sub-area extending from a side of the main area, the main area comprising a display area in which a plurality of emission areas are disposed in a first direction and a second direction, and a non-display area around the display area;
a circuit array layer on the substrate and comprising a plurality of pixel drivers respectively corresponding to the plurality of emission areas, data lines configured to transmit a data signal to the plurality of pixel drivers, and demultiplexer (demux) circuits in a demux area that is in the non-display area, the demux area being on a first side of the non-display area; and
a display driving circuit in the sub-area of the substrate and configured to supply corresponding data driving signals to the data lines,
wherein one of the demux circuits is configured to output two or more data signals based on one of the data driving signals,
wherein the circuit array layer comprises spider lines comprising first spider lines and extending from the display driving circuit, and demux connection lines respectively connected to the first spider lines,
wherein one of the demux connection lines corresponds to a plurality of data lines among the data lines,
wherein the display driving circuit is on a second side of the non-display area that is opposite to the first side in the second direction.

12. The display device of claim 11, wherein the spider lines further comprise second spider lines connected to a floating line.

13. The display device of claim 12, wherein the floating line is in a floating state.

14. The display device of claim 12, wherein the floating line comprises a line configured to apply a voltage to the plurality of pixel drivers.

15. The display device of claim 11, wherein each of the demux connection lines extends from the display area toward the demux area.

16. The display device of claim 11, wherein the circuit array layer further comprises:
demux input lines respectively connecting the demux connection lines to the demux circuits, and
demux output lines respectively connecting the demux circuits to the data lines, and
wherein one of the demux input lines corresponds to a plurality of demux output lines among the demux output lines.

17. The display device of claim 11, wherein the circuit array layer further comprises scan lines extending in the first direction and configured to transmit a scan signal to the plurality of pixel drivers.

18. The display device of claim 17, wherein the non-display area comprises a scan driving circuit area adjacent to at least one side of the display area in the first direction,
wherein the circuit array layer further comprises a scan driving circuit corresponding to the scan driving circuit area, and
wherein the scan driving circuit is configured to respectively supply scan signals to the scan lines.

19. An electronic device comprising:
at least one processor; and
the display device of claim 1 configured to display an image on pixels under control of the at least one processor.

20. An electronic device comprising:
a display device, wherein the display device comprises:
a substrate comprising a main area and a sub-area extending from a side of the main area, the main area comprising a display area in which a plurality of emission areas are disposed in a first direction and a second direction, and a non-display area around the display area, the non-display area comprising a first side adjacent to the sub-area and a second side opposite to the first side in the first direction with the display area therebetween;
a circuit array layer on the substrate and comprising a plurality of pixel drivers respectively corresponding to the plurality of emission areas, data lines configured to transmit a data signal to the plurality of pixel drivers, and demultiplexer (demux) circuits in a demux area that is in the second side of the non-display area; and
a display driving circuit in the sub-area of the substrate and configured to supply corresponding data driving signals to the data lines,
wherein one of the demux circuits is configured to output two or more data signals based on one of the data driving signals,
wherein the circuit array layer comprises spider lines comprising first spider lines and extending from the display driving circuit to the demux area, and demux connection lines respectively connected to the first spider lines, and
wherein one of the demux connection lines corresponds to a plurality of data lines among the data lines.
